(19) United States
(12) Patent Application Publication
(10) Pub. No.: US 2005/0232593 A1
(43) Pub. Date: Oct. 20, 2005

(54) Recording/reproduction device and method thereof

(75) Inventor: Yuichi Kanai, Bisai (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/078,627

(22) Filed: Mar. 14, 2005

(30) Foreign Application Priority Data
Mar. 30, 2004 (JP) 2004-101497
Feb. 1, 2005 (JP) 2005-025628

(51) Int. Cl. H04N 5/76; G11B 15/04; G11B 19/04

(52) U.S. Cl. 386/94; 360/60; 380/201

(57) ABSTRACT

The present invention provides a recording/reproduction device which allows reproduction with a small delay. The recording/reproduction device encrypts digital contents, and records the encrypted digital contents on a removable HDD unit. At the time of reproduction, the recording/reproduction device decrypts the encrypted digital contents recorded on the removable HDD unit. A contents key for decrypting the digital contents is input/output by executing a series of cryptography input/output processing actions. In the event that the removable HDD unit enters the state wherein the removable HDD unit can be used, the recording/reproduction device executes reproduction session establishment processing including device authentication processing beforehand. In the event that there are any sessions which can be established in parallel for executing cryptography input/output processing, recording session establishment processing is executed. Upon reception of user instructions for reproduction, the recording/reproduction device skips device authentication processing, and executes the subsequent cryptography input/output processing for acquiring the contents key.

### BACKGROUND OF THE INVENTION

1. Field of the Invention

The present invention relates to a recording/reproduction technique, and particularly to a recording/reproduction device for encrypting and inputting/outputting data which is to be kept secret, and a method thereof.

2. Description of the Related Art

In recent years, handling of audio contents and video contents in the form of digital contents is becoming wide-spread. For example, terrestrial digital broadcasting has been introduced. Digital contents enable recording without deterioration in image quality or sound quality, thereby markedly improving ease-of-use for the user. However, such a technique which allows the user to make a copy without restriction leads to serious copyright infringement concerns. Accordingly, development of a device for recording/reproducing digital contents must be made giving sufficient consideration to copyright protection.

As a digital-contents reproduction technique developed giving consideration to copyright protection, a technique has been proposed wherein a decryption key used for encrypted contents is encrypted based upon the public key cryptosystem for input/output (e.g., see International Publication WO 01-043339). Decryption of the data encrypted based upon the public key cryptosystem requires a considerable amount of calculation, meaning that a great amount of time is necessary for decryption. Accordingly, the data-reproduction device disclosed in International Publication WO 01-043339 has an arrangement for performing authentication processing based upon the public key cryptosystem prior to reproduction, thereby realizing smooth reproduction.

While the data-reproduction device disclosed in International Publication WO 01-043339 has an arrangement wherein encrypted contents data is decrypted using a license key received from a single memory card at the time of reproduction, the present inventors have proposed an arrangement including multiple input/output paths for confidential data in their development of a device having recording and reproducing functions. Such a configuration requires a technique for effectively using the multiple input/output paths for inputting/outputting confidential data. Furthermore, such a device further having a function which allows the user to connect multiple storage media thereto leads to a more complicated situation.

### SUMMARY OF THE INVENTION

The present invention has been made in view of the above problems, and accordingly, it is an object thereof to provide a technique for improving a device for encrypting the data which is to be kept secret for input/output while improving ease-of-use for the user.

A first aspect of the present invention relates to a recording/reproduction device. The recording/reproduction device comprises: a cryptography processing unit having a configuration which allows execution of a series of cryptography input/output processing actions in parallel, for encrypting the data which is to be kept secret, so as to be input/output to/from a storage medium for storing the data; and a management unit for managing the multiple cryptography input/output processing actions. In the event that the storage medium enters the state wherein the storage medium can be used, the management unit instructs the cryptography processing unit to execute session establishment processing including at least part of the series of cryptography input/output processing actions. Furthermore, reproduction session establishment processing for reading out the data, which is to be kept secret, from the storage medium is executed with higher priority than with recording session establishment processing for writing the data, which is to be kept secret, to the storage medium.

The data which is to be kept secret may be a contents key for decrypting encrypted digital contents, and so forth, for example. Examples of the cryptography input/output processing include: device authentication processing based upon the public key cryptosystem; transmission/reception processing for a temporary contents key for encrypting the data which is to be kept secret; transmission/reception processing for the encrypted data which is to be kept secret; and so forth. With the recording/reproduction device according to the present invention, at least part of a series of the aforementioned processing actions is executed beforehand. This allows the operation of the recording/reproduction device wherein, upon reception of the user instructions for recording or reproduction of the digital contents, the session establishment processing is skipped, and the subsequent cryptography input/output processing is executed, thereby reducing a delay from the user instructions up to the actual recording or reproduction. Furthermore, with the recording/reproduction device according to the present invention, the reproduction sessions are established with higher priority than with the recording sessions, thereby reducing a delay at the time of reproduction, and thereby improving the ease-of-use for the user.

The storage medium may be provided for a storage device removably mounted on the recording/reproduction device. Furthermore, the recording/reproduction device may have a configuration which allows the user to connect the multiple storage devices thereto, and further may include a detecting unit for detecting whether or not each of the multiple storage devices is connected to the recording/reproduction device. An arrangement may be made wherein, in the event that the detecting unit has detected the storage device connected to the recording/reproduction device, the management unit executes the aforementioned session establishment processing.

The session establishment processing may include processing wherein a device serving as a source of the data which is to be kept secret authenticates a device serving as a destination for the data which is to be kept secret. The authentication processing based upon the public key cryptosystem requires relatively long time. With the recording/reproduction device according to the present invention, the authentication processing is executed beforehand at the point that the storage device has entered the state wherein the storage device can be used, thereby reducing a delay at the time of reproduction.

An arrangement may be made wherein, in the event that the number of the storage media, which are connected to the recording/reproduction device and can be used, is smaller than the number of the cryptography input/output processing actions which the cryptography processing unit can execute in parallel, the management unit instructs the cryptography processing unit to execute the reproduction session establishment processing for allowing exchange of information between the recording/reproduction device and each storage medium which can be used, thereby enabling the cryptography processing unit to perform subsequent readout of the data, which is to be kept secret, from each storage medium without the reproduction session establishment processing until the storage medium enters the state wherein the storage medium cannot be used. The reproduction session for which the storage medium has been authenticated is maintained for maintaining the standby state for reproduction as long time as possible. This reduces delay at the time of reproduction.

An arrangement may be made wherein, in the event that the number of the storage media, which are connected to the recording/reproduction device and can be used, is equal to or greater than the number of the cryptography input/output processing actions which the cryptography processing unit can execute in parallel, at the time of writing the data which is to be kept secret, to the storage medium, the management unit instructs the cryptography processing unit to release one of the reproduction sessions thus established for the storage media, and to execute the cryptography input/output processing for writing the data which is to be kept secret, to the storage medium, following which the management unit instructs the cryptography processing unit to execute the reproduction session establishment processing again. With the recording/reproduction device according to the present invention, even in the event that there is the need to temporarily release the established reproduction session due to the shortage of the sessions which can be established in parallel at the time of recording of the program, upon completion of recording of the program, the reproduction session is established again instead of the recording session, whereby the recording/reproduction device enters the standby state for reproduction. This reduces delay at the time of reproduction.

A second aspect of the present invention relates to a recording/reproduction method. The recording/reproduction method wherein a series of cryptography input/output processing actions is executed in parallel for encrypting the data which is to be kept secret for input/output of the encrypted data to/from a storage medium for storing data comprises: a step wherein, in the event that the storage medium enters the state wherein the storage medium can be used, reproduction session establishment processing is executed, which includes at least part of the series of cryptography input/output processing actions for reading out the data which is to be kept secret, from the storage medium; a step wherein, in the event that there are any sessions which can be established in parallel for executing the series of cryptography input/output processing actions after execution of the reproduction session establishment processing for the storage media which can be used, recording session establishment processing is executed, which includes at least part of the series of cryptography input/output processing actions for writing the data which is to be kept secret, to the storage medium; a step for awaiting instructions for readout of the data which is to be kept secret, after execution of the reproduction session establishment processing; and a step wherein, in a case of reception of the instructions of readout of the data, the reproduction session establishment processing of the series of cryptography input/output processing is skipped, and the subsequent processing thereof is executed.

Note that any combination of the aforementioned components or any manifestation of the present invention realized by modification of method, system, recording medium, computer program, and so forth, is effective as an embodiment of the present invention.

Moreover, this summary of the invention does not necessarily describe all necessary features so that the invention may also be sub-combination of these described features.

### BRIEF DESCRIPTION OF THE DRAWINGS

FIG. 1 is a diagram which shows a configuration of a recording/reproduction device according to a first embodiment;

FIG. 2 is a diagram which shows a configuration of a removable HDD unit according to the first embodiment;

FIG. 3 is a diagram which shows an example of an address structure of the storage area of the removable HDD unit;

FIG. 4 is a diagram which shows a directory/file structure for recording the program on the removable HDD unit;

FIG. 5 is a diagram which shows an example of the structure of a program management file;

FIG. 6 is a flowchart which shows the schematic operation of the recording/reproduction device for recording the program data on the removable HDD unit;

FIG. 7 is a flowchart which shows the schematic operation of the recording/reproduction device for reproducing the program data recorded on the removable HDD unit;

FIG. 8 is a diagram which shows a simple model of an example of authentication processing and license-data transmission processing for recording of the license data shown in FIG. 6;

FIG. 9 is a diagram which shows a simple model of an example of authentication processing and license-data transmission processing for readout of the license data shown in FIG. 7;

FIG. 10 is a diagram which shows the procedure for initializing routine regarding the recording/reproduction device according to the first embodiment;

FIG. 11 is a diagram which shows the procedure for recording of the program according to user instructions for recording of the program;

FIG. 12 is a diagram which shows the procedure for reproduction of the program according to user instructions for reproduction of the program;

FIG. 13 is a diagram which shows the configuration of the recording/reproduction device according to a second embodiment;

FIG. 14 is a diagram which shows transition of the states each of which represents the state of the power supply for the recording/reproduction device shown in FIG. 13 and the number of removable HDD units which have been detected as removable HDD units inserted to removable HDD slots;

FIG. 15 is a diagram which shows the procedure for the initializing routine in a case of state transition (2), (4), or (5) shown in FIG. 14;

FIG. 16 is a diagram which shows the procedure for the initializing routine in a case of state transition (3) or (6) shown in FIG. 14;

FIG. 17 is a diagram which shows the procedure for recording the program data on one of the removable HDD units in the state wherein the two removable HDD units can be used;

FIG. 18 is a diagram which shows an example of transition of the sessions with regard to the recording/reproduction device according to a third embodiment; and

FIG. 19 is a diagram which shows a configuration of a recording/reproduction device according to a fifth embodiment.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

### First Embodiment

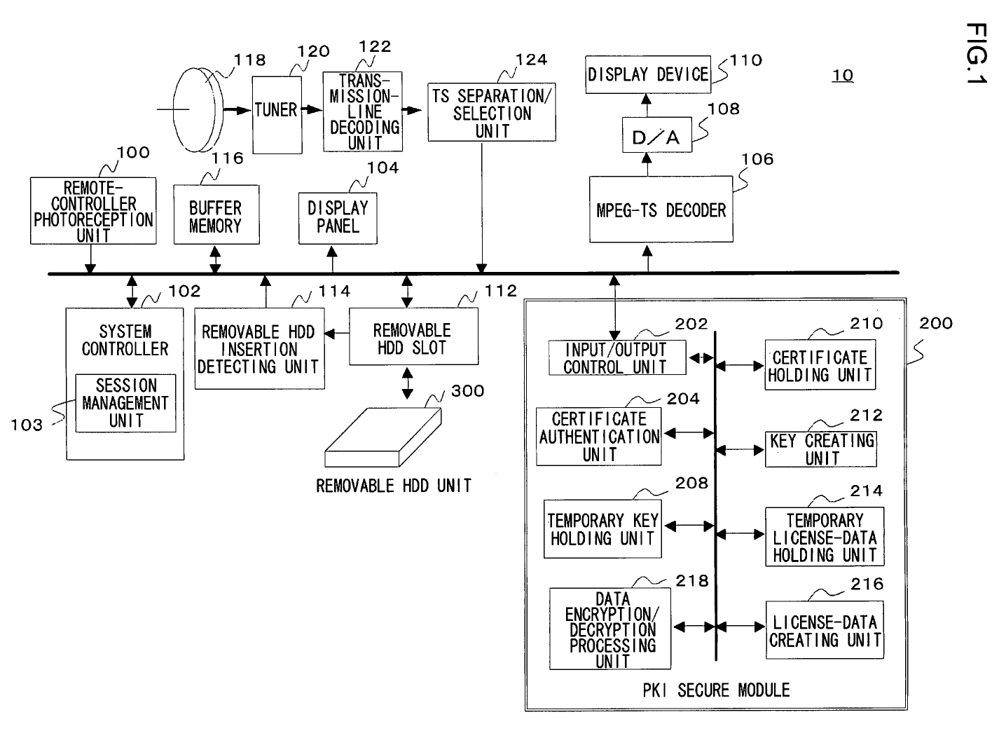

FIG. 1 shows a configuration of a recording/reproduction device 10 according to a first embodiment. The recording/reproduction device 10 has functions serving as a receiving device for receiving digital broadcasting, a recording device for recording the program (contents) of the received digital broadcasting on a storage medium, and a reproduction device for reproducing the program recorded on the storage medium. With the present embodiment, a removable hard-disk drive (HDD) unit 300 removably mounted on the recording/reproduction device 10 is employed as a storage device including a storage medium, for example.

At the time of recording the video/audio data of the received program (which will be simply referred to as “program data” hereafter) on the removable HDD unit 300, the recording/reproduction device 10 according to the present embodiment encrypts the program data using an encryption key prior to recording thereof, for copyright protection. The key used for encrypting the program data will be referred to as “contents key” hereafter. While the program data may be encrypted based upon any desired cryptosystem, description will be made in the present embodiment regarding an arrangement wherein the program data is encrypted based upon the symmetric key cryptosystem. With such a configuration, both the encryption and decryption of the program data are performed using the same key. The encryption of the program data has a low risk of being broken even in a case of data leakage, and accordingly, the encrypted program data is input/output according to ordinary read/write commands. On the other hand, the contents key required for reproducing the program data is highly secret data which requires security against leakage thereof, and accordingly, the contents key is input/output according to a special input/output protocol which gives high priority to security thereof (which will be referred to as “secure protocol” hereafter). With the present embodiment, a secure protocol based upon the public key cryptosystem is employed, and the program is recorded on a removable storage medium; accordingly, such an arrangement requires device-authentication processing prior to recording of the program, or reproducing thereof. With the secure protocol according to the present embodiment, authentication processing is performed using a device certificate. Upon confirmation of the validity of the certificate, the recording/reproduction device 10 establishes a session for transmission/reception of confidential data (which will be referred to as “secure session” hereafter).

At the time of reproducing the program data recorded on the removable HDD unit 300, the recording/reproduction device 10 needs to read out the contents key from the removable HDD unit 300 using the secure protocol. However, public key cryptosystem requires a relatively long time for decryption processing due to a large amount of calculation. Accordingly, an arrangement wherein the contents key is read out according to user instructions for reproduction leads to a delay of actual reproduction from the point in time that the user has made instructions for reproduction, resulting in a slower response than the user anticipates.

In order to solve the aforementioned problem, the recording/reproduction device 10 according to the present embodiment has a PKI secure module 200 which allows multiple processing sessions for input/output using the secure protocol in parallel. With such a configuration, these sessions are assigned to reproduction with high priority. Specifically, upon turning on the power supply, inserting the removable HDD unit 300 into the recording/reproduction device 10, and so forth, which allow the recording/reproduction device 10 to use the removable HDD unit 300, the recording/reproduction device 10 performs authentication processing in public key cryptosystem which requires relatively long processing time beforehand, so as to establish a session for reproduction with high priority, whereby the recording/reproduction device 10 enters the standby state awaiting instructions for reproduction from the user. This reduces the delay from the reception of the instructions for reproduction up to the actual reproduction.

First, description will be made regarding an arrangement according to the first embodiment, wherein the recording/reproduction device 10 has a configuration which allows the user to connect the single removable HDD unit 300 thereto, and performs processing with two secure sessions in parallel. Then description will be made regarding an arrangement according to a second embodiment, wherein the recording/reproduction device 10 has a configuration which allows the user to connect the two removable HDD units 300 thereto, and performs processing with two secure sessions in parallel. Subsequently, description will be made regarding an arrangement according to a third embodiment, wherein the recording/reproduction device 10 has a configuration which allows the user to connect the two removable HDD units 300 thereto, and performs processing with three secure sessions in parallel. Finally, description will be made regarding an arrangement according to a fourth embodiment, wherein the recording/reproduction device 10 has a configuration which allows the user to connect a desired predetermined number of removable HDD units 300 thereto, and performs processing with a desired predetermined number of secure sessions in parallel.

The recording/reproduction device 10 includes a remote-controller photoreception unit 100, a system controller 102, a display panel 104, an MPEG-TS decoder 106, a D/A converter 108, a display device 110, a removal HDD slot 112, a removal HDD insertion detecting unit 114, buffer memory 116, an antenna 118, a tuner 120, a transmission-line decoding unit 122, a TS separation/selection unit 124, a PKI secure module 200 which is an example of a cryptography processing unit.

The remote-controller photoreception unit 100 receives the light emitted from a remote controller (not shown) which allows the user to input instructions to the recording/reproduction device 10, thereby acquiring the instructions from the user. The system controller 102 controls each component of the recording/reproduction device 10. The system controller 102 includes a session management unit 103 for management of establishment of a secure session, release thereof, and so forth, performed by the PKI secure module 200. Note that the session management unit 103 manages the multiple secure sessions with session IDs described later. The session management unit 103 may be included within the PKI secure module 200. The display panel 104 displays various kinds of control information. The MPEG-TS decoder 106 decodes MPEG-TS signals. The D/A converter 108 converts digital signals into analog signals. The display device 110 displays the program data which has been decoded and converted into analog signals.

The removable HDD slot 112 allows the user to connect the removable HDD unit 300 which is a storage medium for recording the program data, to the recording/reproduction device 10. The removal HDD insertion detecting unit 114 detects whether the removable HDD unit 300 has been attached/detached to/from the removable HDD slot 112. The buffer memory 116 has functions serving as a storage area for storing data necessary for the operation of the recording/reproduction device 10, e.g., for temporarily storing MPEG/TS signals which have been separated and selected by the TS separation/selection unit 124.

The antenna 118 receives broadcasting signals subjected to digital conversion. The tuner 120 extracts the signals of the channel selected by the user, from the broadcasting signals received with the antenna 118, according to instructions from the system controller 102. The transmission-line decoding unit 122 decodes the signals extracted by the tuner 120, in the format of video/audio data coded in the MPEG2, and outputs the decoded data to the TS separation/selection unit 124. In the event that the program data is not stored in the removable HDD unit 300, the TS separation/selection unit 124 outputs MPEG transport stream signals to the MPEG-TS decoder 106. The MPEG-TS decoder 106 decodes the MPEG TS signals separated by the TS separation/selection unit 124. The D/A converter 108 converts the digital signals decoded by the MPEG-TS decoder 106, in the form of analog signals. The display device 110 displays the program data in the form of analog signals converted by the D/A converter 108. The PKI secure module 200 controls communication between the recording/reproduction device 10 and the removable HDD unit 300 using the secure protocol.

The PKI secure module 200 includes an input/output control unit 202, a certificate authentication unit 204, a temporary key holding unit 208, a certification holding unit 210, a key creating unit 212, a temporary license-data holding unit 214, a license-data creating unit 216, and a data encryption/decryption processing unit 218. Part or all of the aforementioned components may be realized by hardware means, e.g., by actions of a CPU, memory, and other LSIS, of a computer, and by software means, e.g., by actions of a program or the like, loaded to the memory. Here, the drawing shows a functional block configuration which is realized by cooperation of the hardware components and software components. It is needless to say that such a functional block configuration can be realized by hardware components alone, software components alone, or various combinations thereof, which can be readily conceived by those skilled in this art.

The input/output control unit 202 controls input/output of data between each component within the PKI secure module and an external component. The PKI secure module 200 stores confidential information such as a contents key, license data, and so forth, and accordingly, has a configuration which protects such confidential information from direct access from an external device, thereby preventing leakage of the confidential information. The certificate authentication unit 204 authenticates the validity of the certificate transmitted from the removable HDD unit 300. The temporary key holding unit 208 temporarily holds a key used in the secure session. The certificate holding unit 210 holds the certificate of the recording/reproduction device 10. The aforementioned certificate has been authenticated by an authentication authority, and includes an embedded public key of the recording/reproduction device 10. Note that the certificate is encrypted by the secret key of the authentication authority. The key creating unit 212 creates a key used in the secure session. The temporary license-data holding unit 214 temporarily holds the license data of the program received from the removable HDD unit 300 at the time of reproducing the program recorded on the removable HDD unit 300. The license-data creating unit 216 creates license data including the contents key and license information at the time of recording the program on the removable HDD unit 300. The data encryption/decryption processing unit 218 performs encryption processing for the data, and decryption processing for encrypted data.

The PKI secure module 200 according to the present embodiment manages the commands, encryption/decryption key, and so forth, using session IDs for distinguishing the sessions, thereby enabling parallel processing of the two secure sessions. Specifically, the session IDs are assigned to the input/output commands for allowing distinguishing of which session the command belongs to. Furthermore, at the time of storing the contents key, license data, and so forth, in the temporary key-holding unit 208 and the temporary license-data holding unit 214, such data is stored along with the corresponding session ID. The same can be said of an arrangement wherein the PKI secure module 200 performs processing with three or more sessions in parallel.

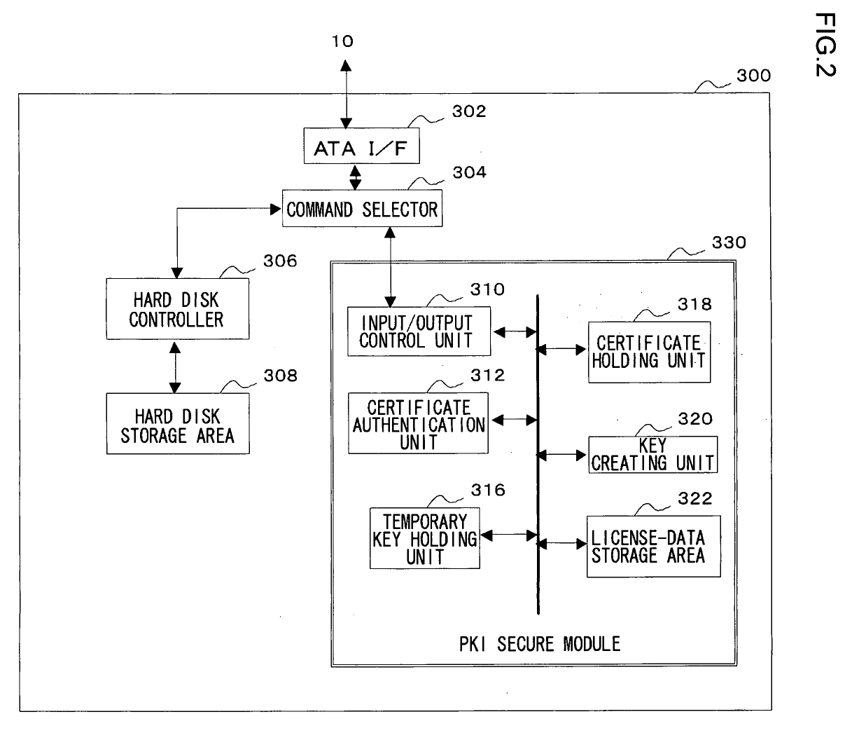

FIG. 2 shows a configuration of the removable HDD unit 300 including a built-in PKI secure module. The removable HDD unit 300 includes a built-in PKI secure module 330 for handling cryptography input/output processing using the PKI method. The removable HDD unit 300 includes an ATA interface 302, a command selector 304, a hard disk controller 306, a hard disk storage area 308, and the PKI secure module 330. Such a configuration may be realized in various forms, e.g., by hardware means alone, by software means alone, or by a combination thereof.

The ATA interface 302 accepts the command stipulated by the ATA (AT attachment) which is the standard of the ANSI (American National Standards Institute). Upon reception of the command issued by the recording/reproduction device 10, the command selector 304 determines whether the received command is an ordinary command or a secure-protocol command. In a case of an ordinary command, the command selector 304 transmits the command to the hard disk controller 306. On the other hand, in a case of a secure-protocol command, the command selector 304 transmits the command to the PKI secure module 330. Upon reception of the ordinary input/output command, the hard disk controller 306 writes/reads the data to/from the hard disk storage area 308. The PKI secure module 330 controls communication between the removable HDD unit 300 and the recording/reproduction device 10 using the secure protocol.

The PKI secure module 330 includes an input/output control unit 310, a certificate authentication unit 312, a temporary key holding unit 316, a certificate holding unit 318, a key creating unit 320, and a license-data storage area 322. The input/output control unit 310 controls input/output between each component within the PKI secure module 330 and an external component. The PKI secure module 330 stores confidential information such as the contents key, the license data, and so forth, and accordingly, has a configuration which protects such confidential information from direct access from an external device, thereby preventing leakage of the confidential information. The certificate authentication unit 312 authenticates the validity of the certificate transmitted from the recording/reproduction device 10. The temporary key holding unit 316 temporarily holds a key used in the secure session. The certificate holding unit 318 holds the certificate of the removable HDD unit 300. The certificate has been authenticated by the authentication authority, and includes an embedded public key of the removable HDD unit 300. Note that the certificate is encrypted with the secret key of the authentication authority. The key creating unit 320 creates a key used for the secure session. The license-data storage area 322 stores the license data including the contents key for reproducing the program recorded in the removable HDD unit 300.

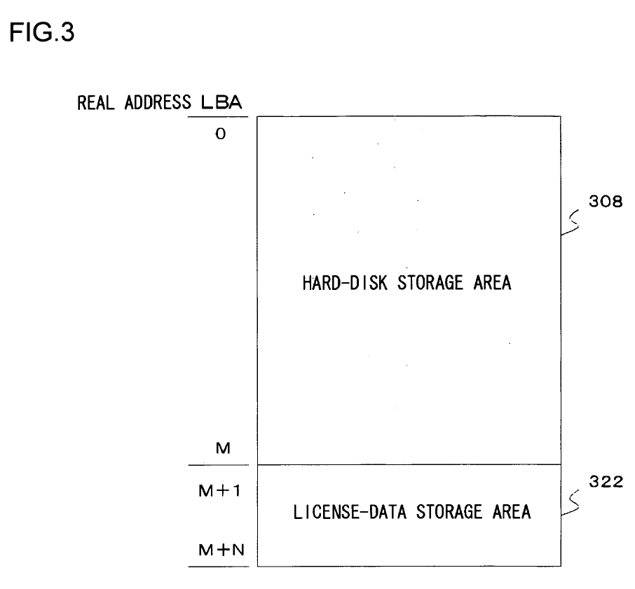

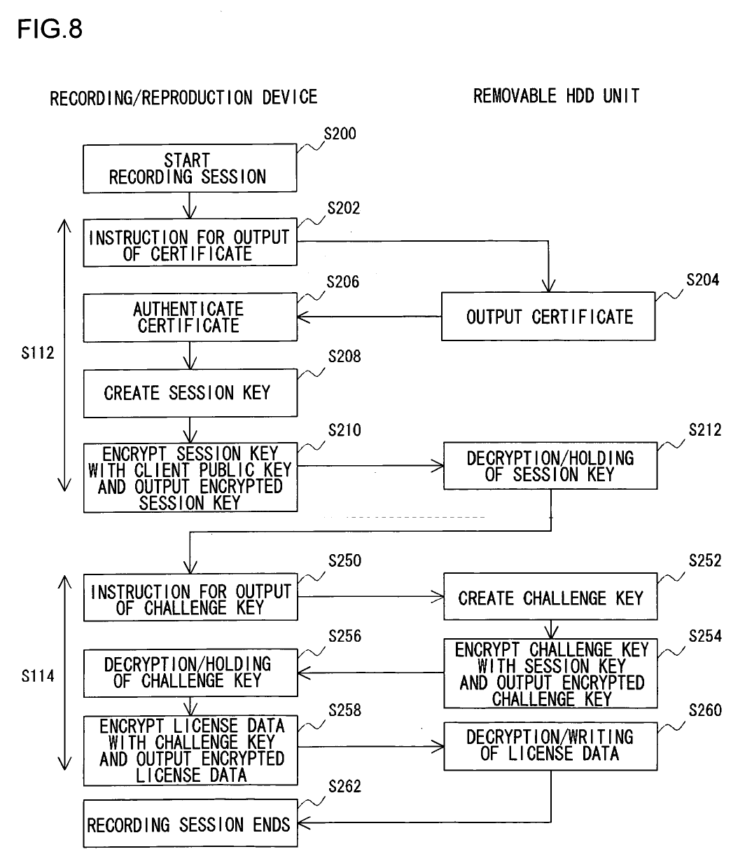

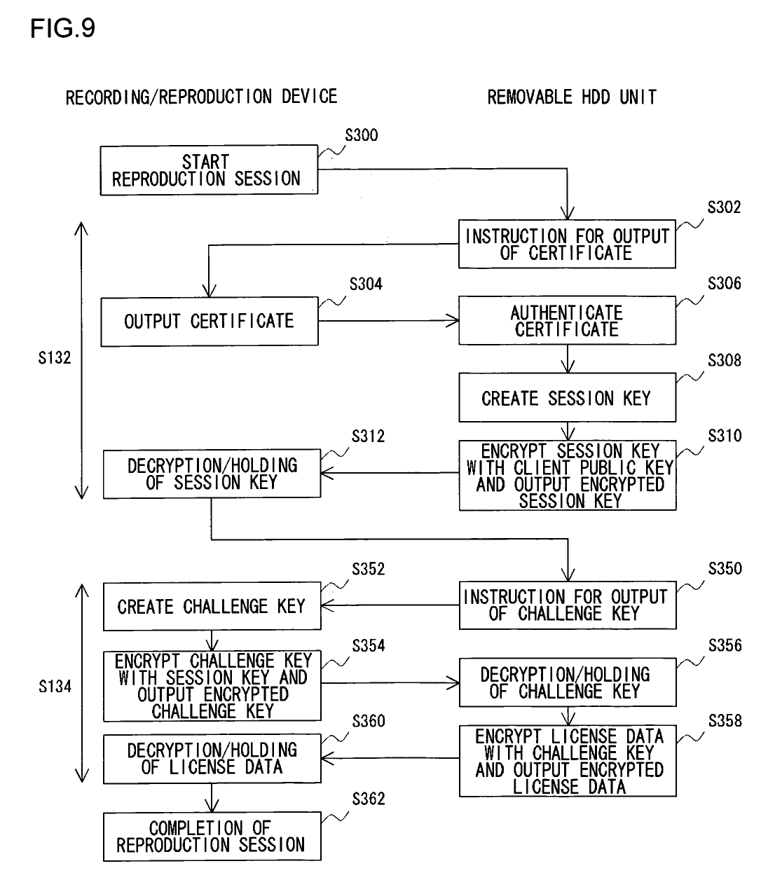

FIG. 3 shows an example of an address structure of the storage area of the removable HDD unit 300. In general, the address of the hard disk is represented by an LBA (Logical Block Address). In an example shown in FIG. 3, the storage area at lower LBAs (0 through M) corresponds to the hard disk storage area 308 shown in FIG. 2. The storage area allows access using ordinary Read/Write commands. On the other hand, the storage area at higher LBAs (M+1 through M+N) corresponds to the license-data storage area 322 shown in FIG. 2. This storage area allows limited access only using special command procedure shown in FIGS. 8 and 9.

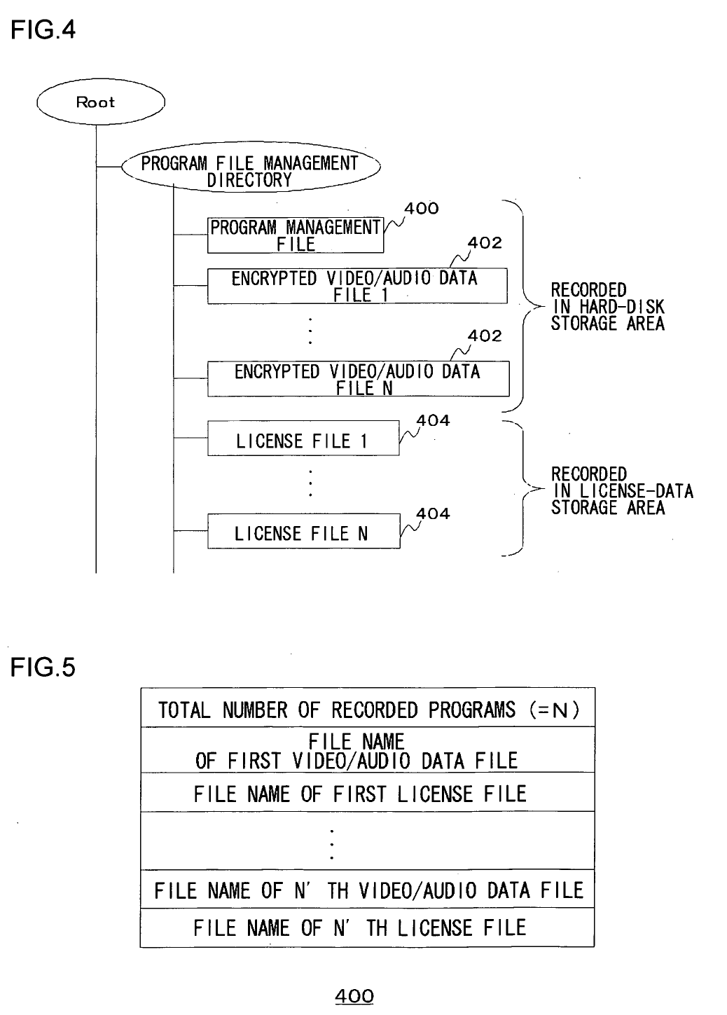

FIG. 4 shows a directory/file configuration of an arrangement wherein the program is recorded on the removable HDD unit 300. The entire information regarding the recorded program is managed under a program file management directory. A program management file 400 is a file for storing the data for managing the recorded programs. An encrypted video/audio data file 402 is a file for storing the data of the program in the format of the encrypted MPEG-TS signal. A license file 404 is a file for storing the license information such as conditions for use of the program and so forth, and license data including the contents key for decrypting the encrypted program data, which is provided for each recorded program. The program management file 400 and the encrypted video/audio data files 402 are recorded in the hard disk storage area 308 shown in FIGS. 2 and 3. On the other hand, the license files 404 are stored in the license-data storage area 322. The data of the program is encrypted for input/output, and accordingly, has a low risk of leakage even in a case wherein the data is recorded in the hard disk storage area 308 using the ordinary read/write commands. Accordingly, with the present embodiment, only the license data is recorded in the license-data storage area 322 using the secure protocol. This enables high-speed read/write of the program data while maintaining sufficient security of the license data.

FIG. 5 shows an example of the structure of the program management file 400. The program management file 400 is a file for recording the management information regarding all the programs recorded on the removable HDD unit 300. First, the number of all the recorded programs is recorded in the program management file 400. Here, the number of all the recorded programs will be represented by N. Subsequently, N combinations of the file name of the encrypted data file and the file name of the corresponding license file are recorded in the program management file 400. This file structure allows the user to perform high-speed and effective file search for the program recorded on the hard disk. Furthermore, this file is used for management of the combinations of the encrypted data and the license, as well.

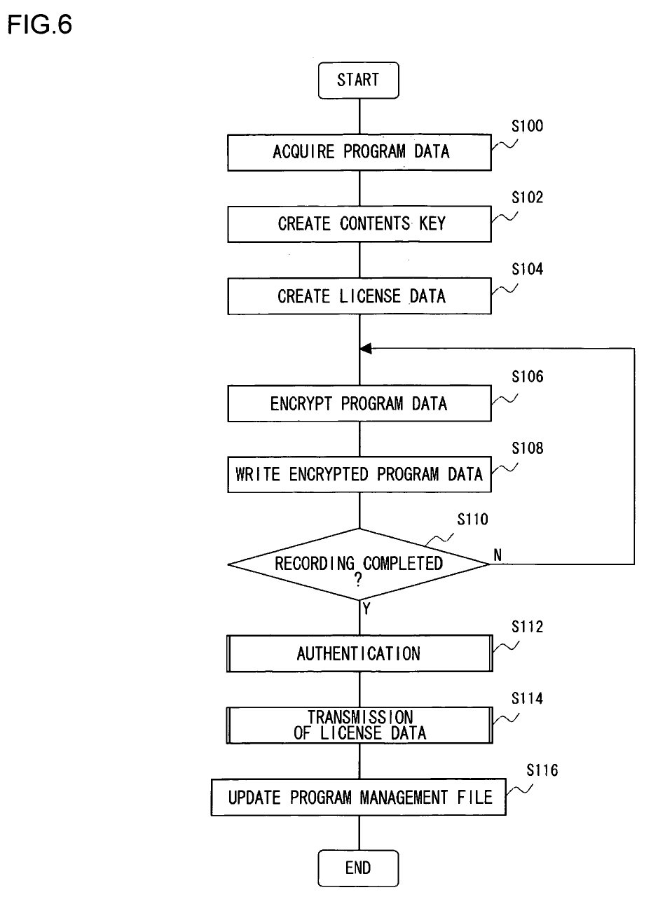

FIG. 6 is a flowchart which shows a schematic operation of the recording/reproduction device 10 at the time of recording the program data on the removable HDD unit 300. While the procedure of the actual processing in the recording/reproduction device 10 is different from the procedure shown in the drawing as described later, description will be made below regarding the operation of the arrangement shown in FIGS. 1 and 2, and description will be made later regarding the procedure of the actual processing.

First, the recording/reproduction device 10 acquires the program data from the digital broadcasting waves (S100). Specifically, the tuner 120 extracts the data of the channel selected by the user, from the broadcasting signals received with the antenna 118. Then, the transmission-line decoding unit 122 decodes the data, and the TS separation/selection unit 124 extracts the MPEG-TS signal, whereby the MPEG-TS signal is transmitted to the PKI secure module 200. The program transmitted to the PKI secure module 200 is transmitted to the data encryption/decryption processing unit 218 through the input/output control unit 202. The license-data creating unit 216 creates the contents key for encrypting the program data (S102). Furthermore, the license-data creating unit 216 extracts the license information such as the conditions for use, from the MPEG-TS signal, so as to create the license data of the program (S104). Let us say that the information regarding the conditions for use includes a digital-copy control descriptor (copy control information), a contents availability descriptor (temporary accumulation information), a parental rating descriptor (age-restriction information), and so forth. The license data includes the license information and the contents key.

The data encryption/decryption processing unit 218 encrypts the program data with the contents key (S106). The encrypted program data is transmitted to the removable HDD unit 300 through the input/output control unit 202 and the removable HDD slot 112. In the removable HDD unit 300, the encrypted program data is recorded in the hard disk storage area 308 through the ATA interface 302, the command selector 304, and the hard disk controller 306 (S108). During recording of the program (in a case of “No” in S110), the procedure for encrypting the program data (S106) and the procedure for writing the program data (S108) are repeated. Upon completion of the recording (in a case of “Yes” in Step S110), the recording/reproduction device 10 authenticates the removable HDD unit 300 (S112). In a case wherein determination has been made that the removable HDD unit 300 is valid, the recording/reproduction device 10 transmits the license data to the removable HDD unit 300 so as to be recorded on the removable HDD unit 300 (S114). Note that authentication of the removable HDD unit 300 and transmission of the license data are performed using the secure protocol based upon the public key cryptosystem. Detailed description will be made later regarding the authentication processing (S112) and the transmission processing for the license data (S114).

Finally, the application program updates the program management file 400 for managing the combinations of the encrypted program data and the license data (S116). An arrangement may be made wherein the recording/reproduction device 10 reads out and updates the program management file 400, following which the recording/reproduction device 10 rewrites the updated program management file 400 to the removable HDD unit 300. Furthermore, an arrangement may be made wherein the recording/reproduction device 10 transmits a command to the hard disk controller 306 or the like, so as to update the program management file 400.

While description has been made regarding an arrangement wherein the PKI secure module 200 of the recording/reproduction device 10 transmits the license data to the PKI secure module 330 of the removable HDD unit 300 following recording of the program data with reference to the drawing, the present invention is not restricted to such an arrangement wherein transmission of the license data is performed following recording of the program. Rather, an arrangement may be made wherein, following creation of the license data in S104, transmission of the license data is performed while transmitting the encrypted program data. Furthermore, an arrangement may be made wherein transmission of the encrypted program data is started following transmission of the license data. In this case, the encrypted program data is stored in the buffer memory 116 during transmission of the license data.

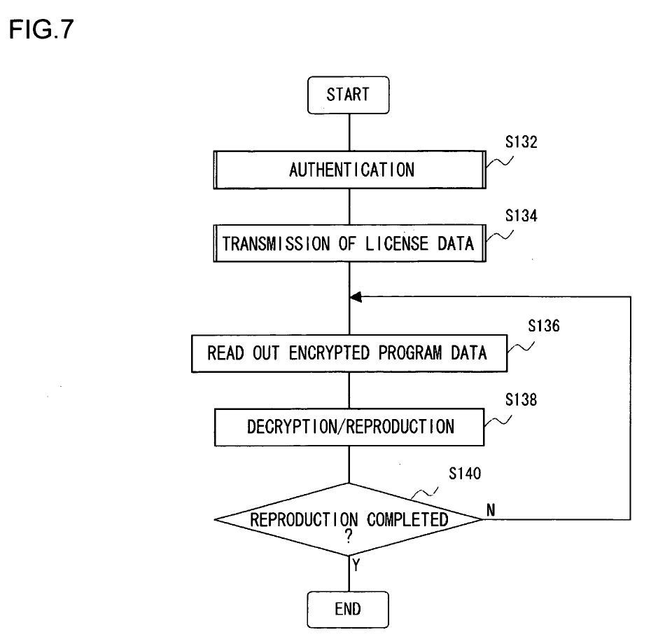

FIG. 7 is a flowchart which shows schematic operation of the recording/reproduction device 10 at the time of reproducing the program data recorded on the removable HDD unit 300. As described later, while the actual procedure for the processing according to the present embodiment is different from that shown in the drawing, description will be made below regarding the operation of the configuration shown in FIGS. 1 and 2, and description will be made later regarding the actual procedure for the processing.

First, the removable HDD unit 300 authenticates the recording/reproduction device 10 (S132) in order to read out the license data-corresponding to the program which is to be reproduced. Upon successful authentication of the recording/reproduction device 10, the license data recorded in the license-data storage area 322 of the removable HDD unit 300 is transmitted to the PKI secure module 200 of the recording/reproduction device 10 (S134). Note that authentication of the recording/reproduction device 10 and transmission of the license data are performed using the secure protocol based upon the public key cryptosystem. Detailed description will be made later regarding the authentication processing (S132) and transmission processing for the license data (S134). The transmitted license data is temporarily held by the temporary license-data holding unit 214.

Next, the encrypted program data is read out from the hard disk storage area 308, and is transmitted to the recording/reproduction device 10 (S136). The data encryption/decryption processing unit 218 of the recording/reproduction device 10 decrypts the encrypted program data using the contents key included in the license data held by the temporary license-data holding unit 214. The decrypted program data is output to the display device 110 through the MPEG-TS decoder 106 and the D/A converter 108, whereby reproduction of the program data is performed (S138). During reproduction of the program (in a case of “No” in S140), the procedure for readout of the encrypted program data (S136) and the procedure for decryption/reproduction (S138) are repeated. Upon completion of reproduction of the program, or upon the user instructing the end of reproduction (in a case of “Yes” in S140), the processing ends.

FIG. 8 shows an example of a simple model of the authentication processing and transmission processing for the license data for recording of the license data shown in FIG. 6. The secure session for recording of the program shown in the drawing will be referred to as “recording session” hereafter. With the present embodiment, the recording session is executed using the secure protocol based upon the public key cryptosystem. Details of the PKI protocol is disclosed in Japanese Unexamined Patent Application Publication No. 2003-248557, for example. While in reality, commands and data are exchanged between: the controller and the PKI secure module 200 of the recording/reproduction device 10; and the controller and the PKI secure module 330 of the removable HDD unit 300; description will be made below with reference to the drawing regarding a simple model wherein the commands and data are exchanged between the recording/reproduction device 10 and the removable HDD unit 300.

First, detailed description will be made regarding the procedure wherein the recording/reproduction device 10 authenticates the removable HDD unit 300 so as to establish the recording session (S112). Upon start of the recording session for recording the license data on the removable HDD unit 300 (S200), first, the recording/reproduction device 10 makes a request to the removable HDD unit 300 for output of a certificate (S202). The removable HDD unit 300 outputs the certificate stored in the certificate holding unit 318 according to the aforementioned request (S204). The certificate authentication unit 20.4 of the recording/reproduction device 10 decrypts the encrypted certificate thus received, using the public key of the authentication authority embedded in the PKI secure module 200, whereby the validity of the certificate is checked (S206). Upon confirmation of the validity of the certificate, the key creating unit 212 creates a session key (S208), encrypts the session key using the public key of the removable HDD unit 300 embedded in the certificate, and outputs the encrypted session key (S210), as well as holding the session key in the temporary holding unit 208. The session key serves as a symmetric key temporarily valid in the recording session. The temporary key holding unit 316 of the removable HDD unit 300 decrypts the encrypted session key thus received, using the secret key of the removable HDD unit 300, and holds the session key (S212). At this point, the recording/reproduction device 10 and the removable HDD unit 300 share the session key.

Next, detailed description will be made regarding the procedure for transmission of the license data to the removable HDD unit 300 performed by the recording/reproduction device 10 (S114). The recording/reproduction device 10 makes a request to the removable HDD unit 300 for output of a challenge key (S250). The key creating unit 320 of the removable HDD unit 300 creates a challenge key according to the aforementioned request (S252). The removable HDD unit 300 encrypts the challenge key with the session key held by the temporary key holding unit 316 and outputs the challenge key thus encrypted (S254) while holding the challenge key in the temporary key holding unit 316. The temporary key holding unit 208 of the recording/reproduction device 10 decrypts the encrypted challenge key thus received, using the session key held by the temporary key holding unit 208, and holds the challenge key thus decrypted (S256). Next, the recording/reproduction device 10 reads out the license data which is to be transmitted to the removable HDD unit 300, from the temporary license-data holding unit 214, encrypts the license data with the challenge key, and outputs the encrypted license data (S258). The removable HDD unit 300 decrypts the encrypted license data thus received at the license-data storage area 322 thereof, using the challenge key held by the temporary key holding unit 316 (S260). Following the aforementioned procedure, this series of recording sessions ends (S262).

FIG. 9 shows an example of a simple model of the authentication processing and the license-data transmission processing for readout of the license data shown in FIG. 7. The secure session for reproduction shown in the drawing will be referred to as “reproduction session” hereafter. With the present embodiment, the reproduction session is executed using a secure protocol based upon the public key cryptosystem. Now, description will be made in the present embodiment regarding a simple model of the reproduction session wherein information is exchanged between the recording/reproduction device 10 and the removable HDD unit 300. The procedure for the reproduction session has the same structure as with the procedure for the recording session shown in FIG. 8 wherein the recording/reproduction device 10 and the removable HDD unit 300 are exchanged.

First, detailed description will be made regarding the procedure wherein the removable HDD unit 300 authenticates the recording/reproduction device 10 so as to establish the reproduction session (S132). Upon start of the reproduction session for readout of the license data from the removable HDD unit 300 (S300), first, the removable HDD unit 300 makes a request to the recording/reproduction device 10 for output of a certificate (S302). The recording/reproduction device 10 outputs the certificate stored in the certificate holding unit 210 according to the aforementioned request (S304). The certificate authentication unit 312 of the removable HDD unit 300 decrypts the encrypted certificate thus received, using the public key of the authentication authority embedded in the PKI secure module 330 so as to check the validity of the certificate (S306). In a case wherein the certificate is valid, the key creating unit 320 creates a session key (S308), and stores the session key in the temporary key holding unit 316. At the same time, the session key is encrypted with the public key of the recording/reproduction device 10 embedded in the certificate, and is output (S310). The session key serves as a symmetric key temporarily valid for the reproduction session. The temporary key holding unit 208 of the recording/reproduction device 10 decrypts the encrypted session key thus received, using the secret key of the recording/reproduction device 10, and holds the session key (S312). At this point, the removable HDD unit 300 and the recording/reproduction device 10 share the session key.

Next, detailed description will be made regarding the procedure for transmission of the license data to the recording/reproduction device 10 performed by the removable HDD unit 300 (S134). The removable HDD unit 300 makes a request to the recording/reproduction device 10 for output of a challenge key (S350). The key creating unit 212 of the recording/reproduction device 10 creates a challenge key according to the aforementioned request (S352). The recording/reproduction device 10 encrypts the challenge key with the session key held by the temporary key holding unit 208 and outputs the challenge key thus encrypted (S354) while holding the challenge key in the temporary key holding unit 208. The temporary key holding unit 316 of the removable HDD unit 300 decrypts the encrypted challenge key thus received, using the session key held by the temporary key holding unit 316, and holds the challenge key thus decrypted (S356). Next, the removable HDD unit 300 reads out the license data which is to be transmitted to the recording/reproduction device 10, from the license-data storage area 322, encrypts the license data with the challenge key, and outputs the encrypted license data (S358). The temporary license-data holding unit 214 of the recording/reproduction device 10 decrypts the encrypted license data thus received, using the challenge key held by the temporary key holding unit 208, (S360). Following the aforementioned procedure, this series of reproduction sessions ends (S362).

While the procedure for transmission/reception of the license data shown in FIGS. 8 and 9 exhibits high security, such procedure requires a great amount of calculation due to high security, leading to long processing time. That is to say, in some cases, such a reproduction procedure for the program shown in FIG. 7 leads to a problem of a time lag from the user instructions for reproduction of the program up to display of the program on the display device 110, resulting in poor ease-of-use for the user. With the present embodiment, part of the necessary processing is performed beforehand, thereby realizing smooth processing from the user instructions for the program up to display thereof. In general, authentication of the certificate (S206 and S306) and decryption of the asymmetric key (S212 and S312) require a great amount of calculation. With the present embodiment, the device authentication processing (S112 and S132) up to the step wherein the client device decrypts the session key, and holds the decrypted session key, i.e., the server device and the client device share the session key (S212 and S312), is performed beforehand at the time of insertion of the removable HDD unit 300 or the like, as processing for establishing a session. Note that the session establishment processing may consist of steps up to authentication of the certificate (S206 and S306), or may consist of steps up to decryption of the challenge key (S256 and S356). Furthermore, the session establishment processing may consist of steps up to a desired step as long as the session establishment processing includes part of the recording session or the reproduction session. In a case of the recording session, the recording/reproduction device 10 creates the license data according to the user instructions for the program which is to be recorded, and accordingly, transmission of the license data cannot be performed beforehand. On the other hand, in a case of the reproduction session, an arrangement may be made wherein all the license data recorded on the removable HDD unit 300 is transmitted to the recording/reproduction device 10 beforehand, for example.

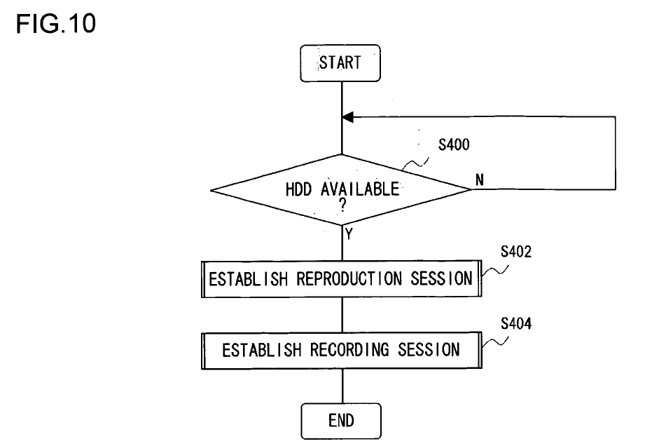

Description will be made regarding the recording procedure and the reproduction procedure for the program with the recording/reproduction device 10 according to the present invention with reference to FIGS. 10, 11, and 12. FIG. 10 shows the procedure for initializing routine regarding the recording/reproduction device 10. First, upon turning on the power supply for the recording/reproduction device 10 in the state wherein the removable HDD unit 300 is inserted into the removable HDD slot 112, or upon inserting the removable HDD unit 300 into the removable HDD slot 112 in the state wherein the power supply for the recording/reproduction device 10 is on, the recording/reproduction device 10 can use the removable HDD unit 300 (in a case of “Yes” in S400). Note that the removable HDD insertion detecting unit 114 detects insertion of the removable HDD unit 300. The recording/reproduction device 10 according to the present embodiment has a configuration which allows processing with two secure sessions in parallel. Accordingly, with the present embodiment, both the reproduction session and the recording session are established beforehand for the removable HDD unit 300. Specifically, the session management unit 103 instructs to execute session establishment processing for reproduction (S112 in FIG. 8) so as to form the reproduction session for exchange of information between the recording/reproduction device 10 and the removable HDD unit 300 (S402). At the same time, the session management unit 103 instructs execution of session establishment processing for recording (S132 in FIG. 9) so as to establish the recording session for exchange of information between the recording/reproduction device 10 and the removable HDD unit 300 (S404). As a result, the recording/reproduction device 10 enters the standby state both for recording and reproduction.

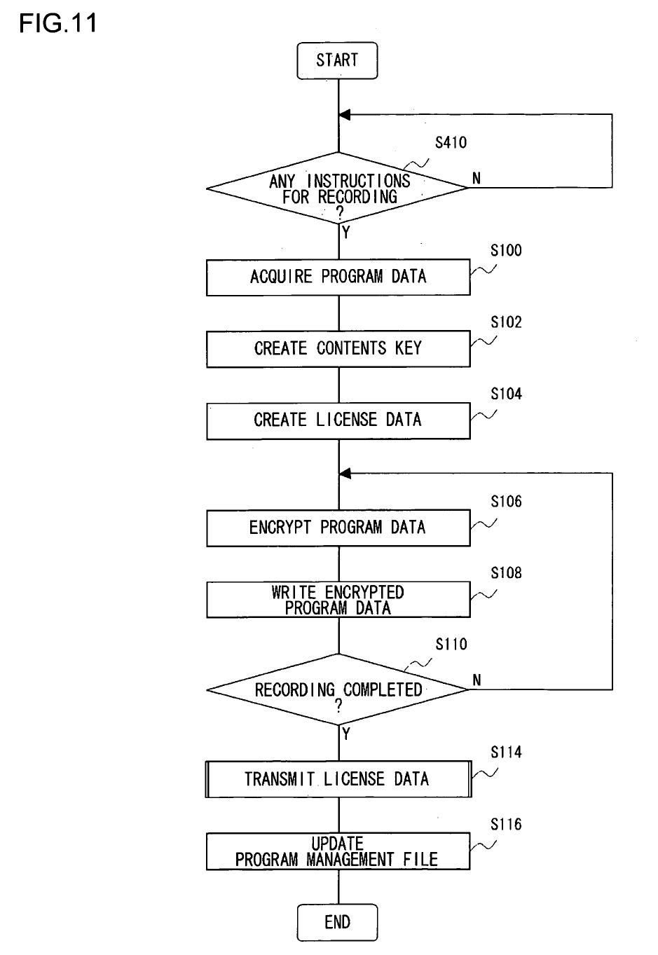

FIG. 11 shows the recording procedure according to user instructions for recording of the program. Following the initializing routine shown in FIG. 10, the recording/reproduction device 10 awaits the recording instructions from the user (in a case of “No” in S410). Upon reception of user instructions for recording of the program with a remote controller or the like (in a case of “Yes” in S410), the recording procedure shown in FIG. 6 is started. The procedure from the step for acquiring the program data (S100) up to the end of recording (in a case of “Yes” in S110) is performed in the same way as the procedure shown in FIG. 6. Upon completion of recording of the program (in a case of “Yes” in S110), only the license-data transmission processing is performed (S114), since the authentication processing (S112 in FIG. 6) has been already performed in the initializing routine shown in FIG. 10. Specifically, the processing is performed from the step for instructing output of the challenge key (S250) up to the step for writing of the license data (S260) shown in FIG. 8. Finally, update processing is performed for the program management file 400 (S116).

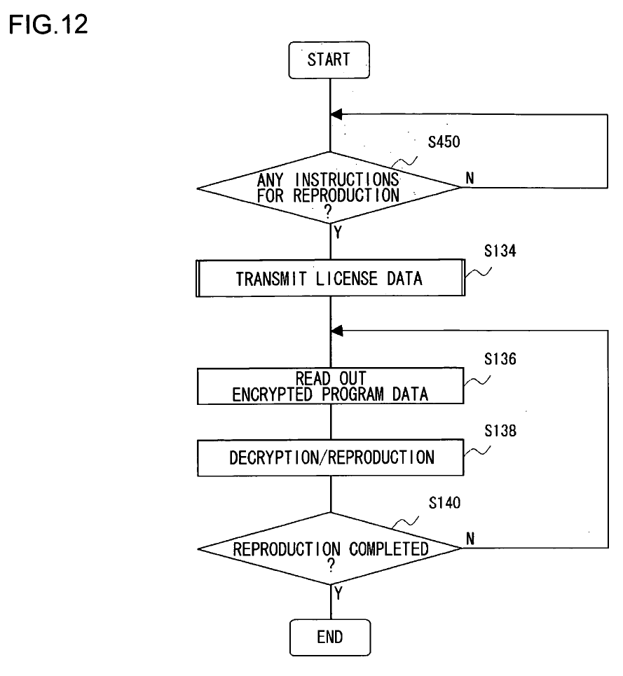

FIG. 12 shows the reproduction procedure according to user instructions for reproduction of the program. Following the initializing routine shown in FIG. 10, the recording/reproduction device 10 awaits the reproduction instructions from the user (in a case of “No” in S450). An arrangement may be made wherein the recording/reproduction device 10 refers to the program management file 400 so as to display a table of the programs wherein the user can reproduce. Upon the user selecting one of the programs recorded on the removable HDD unit 300, and making instructions for reproduction thereof with the remote controller (in a case of “Yes” in S410), the reproduction procedure shown in FIG. 7 is started. In this stage, the authentication processing (S132 in FIG. 7) has been already performed in the initializing routine shown in FIG. 10, and accordingly, only the license-data transmission processing is performed (S134). Specifically, the processing is executed from the step for instructing output of the challenge key shown in FIG. 9 (S350) up to the step for holding the license data (S360). Such processing requires a smaller amount of calculation than with the authentication processing. Accordingly, such a configuration according to the present embodiment reduces the delay from the user instructions for reproduction of the program up to display thereof. Note that the procedure from the step for readout of the encrypted program data (S136) up to completion of reproduction of the program (in a case of “Yes” in S140) is performed in the same way as the procedure shown in FIG. 7.

The recording/reproduction device 10 according to the present embodiment has a configuration which allows establishment of two secure sessions at the same time. Such a configuration allows the recording/reproduction device 10 to maintain the recording session and the reproduction session until the recording/reproduction device 10 cannot use the removable HDD unit 300. That is to say, there is no need to release the recording session and the reproduction session during the period of time wherein the recording/reproduction device 10 can use the removable HDD unit 300. Such a configuration allows the recording/reproduction device 10 to perform recording or reproduction processing according to second or more recording instructions or reproduction instructions without authentication processing (S112 in FIG. 6, and S132 in FIG. 7) as with the procedure shown in FIGS. 11 and 12. This reduces the time lag up to the start of reproduction of the program, thereby improving ease-of-use for the user.

### Second Embodiment

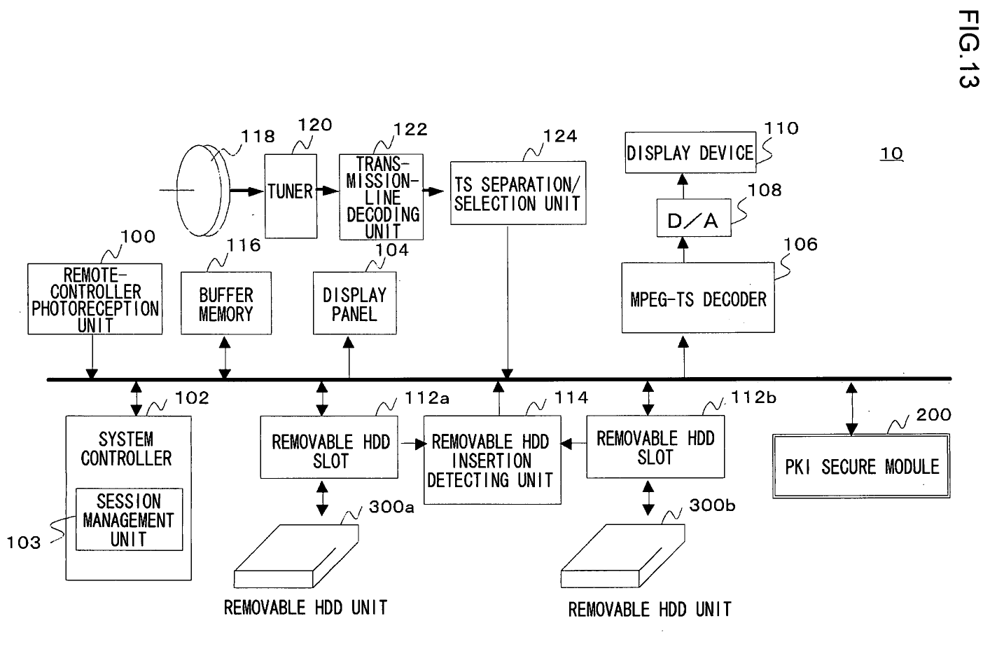

FIG. 13 shows a configuration of the recording/reproduction device 10 according to a second embodiment. The recording/reproduction device 10 according to the present embodiment includes two removable HDD slots 112a and 112b, which allow the user to connect two removable HDD units 300a and 300b to the recording/reproduction device 10. Note that the other components are the same as with the recording/reproduction device 10 according to the first embodiment shown in FIG. 1. With the present embodiment, the PKI secure module 200 and the PKI secure module 330 are provided, which allow parallel processing of two secure sessions, as well. Note that the session management unit 103 manages the two secure sessions.

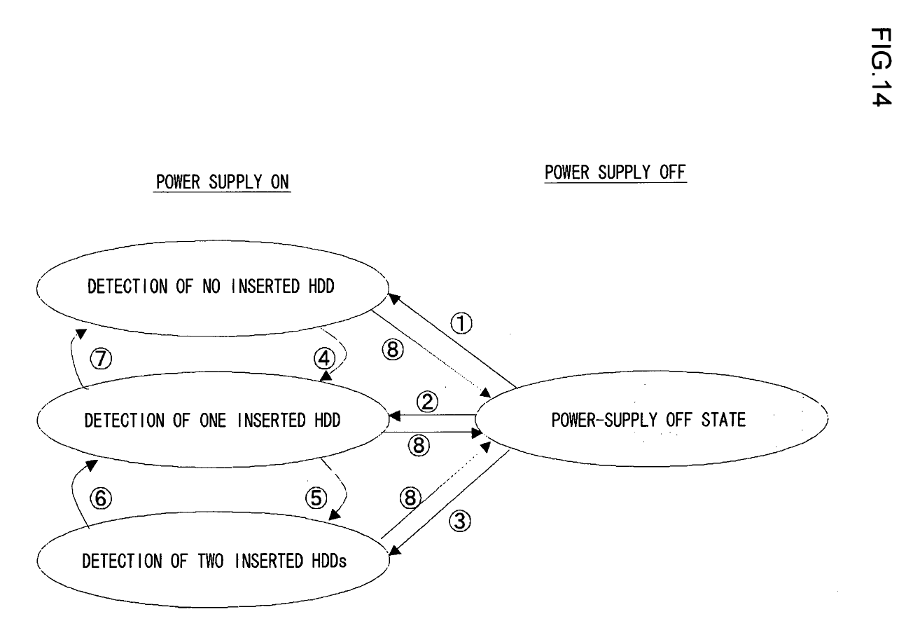

FIG. 14 shows the states and transition therebetween; each state representing the state of the power supply for the recording/reproduction device 10 shown in FIG. 13 and the number of the detected removable HDD units 300 inserted into the removable HDD slots 112a and 112b. The state transitions (1) through (8) will be listed below.

(1) At the time that the power supply is on, no removable HDD unit 300 is detected.

(2) At the time that the power supply is on, the single removable HDD unit 300 is detected.

(3) At the time that the power supply is on, the two removable HDD units 300 are detected.

(4) As a result of insertion of the removable HDD unit 300, the total of one removable HDD unit 300 is detected.

(5) As a result of insertion of the removable HDD unit 300, the total of two removable HDD units 300 is detected.

(6) As a result of disconnection of the removable HDD unit 300, the total of one removable HDD unit 300 is detected.

(7) As a result of disconnection of the removable HDD unit 300, no removable HDD unit 300 is detected.

(8) The power supply is turned off.

Description will be made regarding the initializing routine executed by the session management unit 103 of the recording/reproduction device 10 at the time of transition between the states shown in FIG. 14. In the state which allows the recording/reproduction device 10 to use the single removable HDD unit 300, the session management unit 103 establishes the recording session and the reproduction session for the removable HDD unit 300 as described in the first embodiment. On the other hand, in the state which allows the recording/reproduction device 10 to use the two removable HDD units 300, the session management unit 103 establishes the reproduction sessions for each of these removable HDD units 300. That is to say, the two secure sessions provided for the present embodiment are assigned to reproduction so that each of the two removable HDD units 300a and 300b enters the standby state, thereby reducing a delay from reception of instructions for reproduction of the program up to actual reproduction thereof.

In a case of (1) or (8), the session management unit 103 executes no processing. In a case of (2) or (4), such an arrangement is the same as with the first embodiment, and accordingly, the session management unit 103 executes the initializing routine shown in FIG. 10, for the single removable HDD unit 300 thus detected, whereby both the recording session and the reproduction session are established.

In a case of (3), the session management unit 103 establishes the reproduction sessions for each of the two removable HDD units 300a and 300b. In a case of (5), the recording/reproduction device 10 releases the recording session established for the removable HDD unit 300 which has been detected in the previous stage, so as to establish the reproduction session for the new removable HDD unit 300 detected in this stage. That is to say, the secure session is provided as a reproduction session regarding the new removable HDD unit 300, instead of the recording session for the other removable HDD unit 300. At the time of release of the secure session, the session management unit 103 instructs the temporary key holding units 208 and 316 to remove the temporary keys stored therein, as well as releasing the session ID assigned to the secure session which is to be released so as to allow the recording/reproduction device 10 to use the secure session. That is to say, the secure session is released, which allows the recording/reproduction device 10 to use the secure session for other purposes. In a case of (6), the recording/reproduction device 10 releases the session for the removable HDD unit 300 thus detached so as to establish the recording session for the remaining removable HDD unit 300. That is to say, the secure session is provided as a recoding session regarding the remaining removable HDD unit 300, instead of the reproduction session for the other removable HDD unit 300. In a case of (7), the recording/reproduction device 10 releases the session provided for the removable HDD unit 300 thus detached.

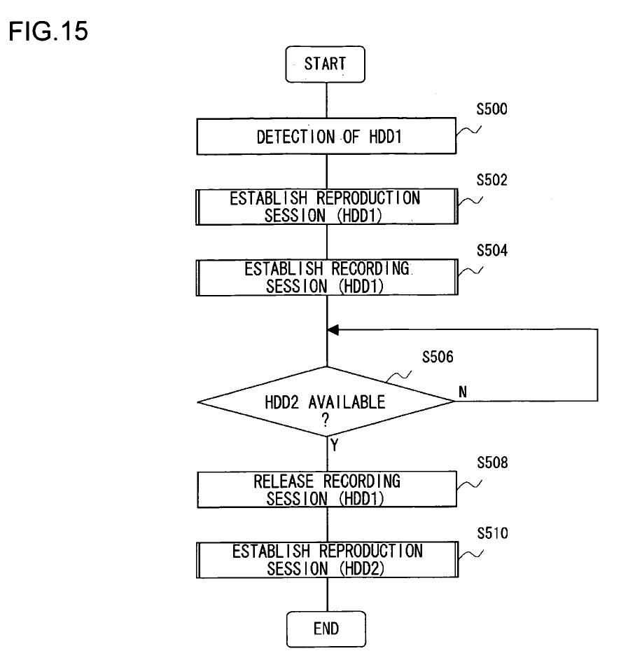

FIG. 15 shows the procedure for the initializing routine at the state transitions (2), (4), or (5) shown in FIG. 14. Upon detection of the single removable HDD unit 300 due to the state transitions (2) or (4) (S500), the session management unit 103 establishes the recording session for the removable HDD unit 300 (S504) as well as the reproduction session (S502). In addition, upon the state transition (5) which allows the recording/reproduction device 10 to use another removable HDD unit 300 (in a case of “Yes” in S506), the recording/reproduction device 10 releases the recording session established for the removable HDD unit 300 detected in the previous stage (S508), and establishes the reproduction session for the new removable HDD unit 300 which has been detected in this stage (S510).

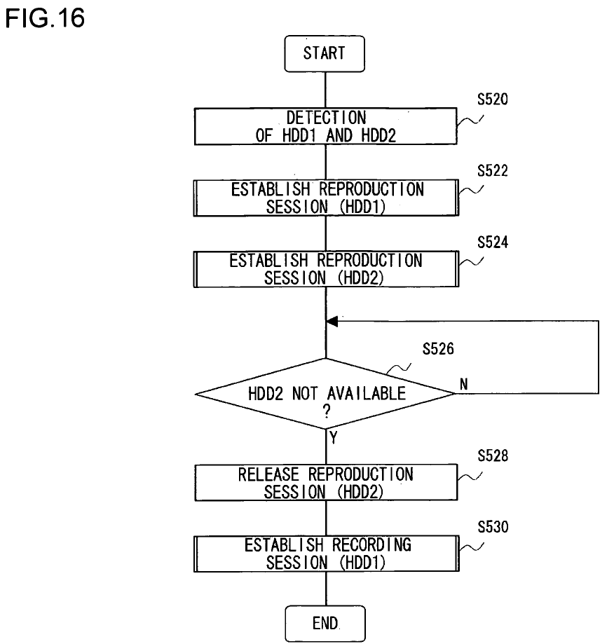

FIG. 16 shows the procedure for the initializing routine at the state transitions (3) or (6) shown in FIG. 14. Upon detection of the two removable HDD units 300 due to the state transition (3) (S520), the session management unit 103 establishes the reproduction session for each of the removable HDD units 300 (S522 and S524). Subsequently, in the event that the recording/reproduction device 10 enters the state wherein one of the removable HDD units 300 cannot be used due to the state transition (6) from the aforementioned state (in a case of “Yes” in S526), the recording/reproduction device 10 releases the reproduction session established for the removable HDD unit 300 (S528), and establishes the recording session for the remaining removable HDD unit 300 (S530).

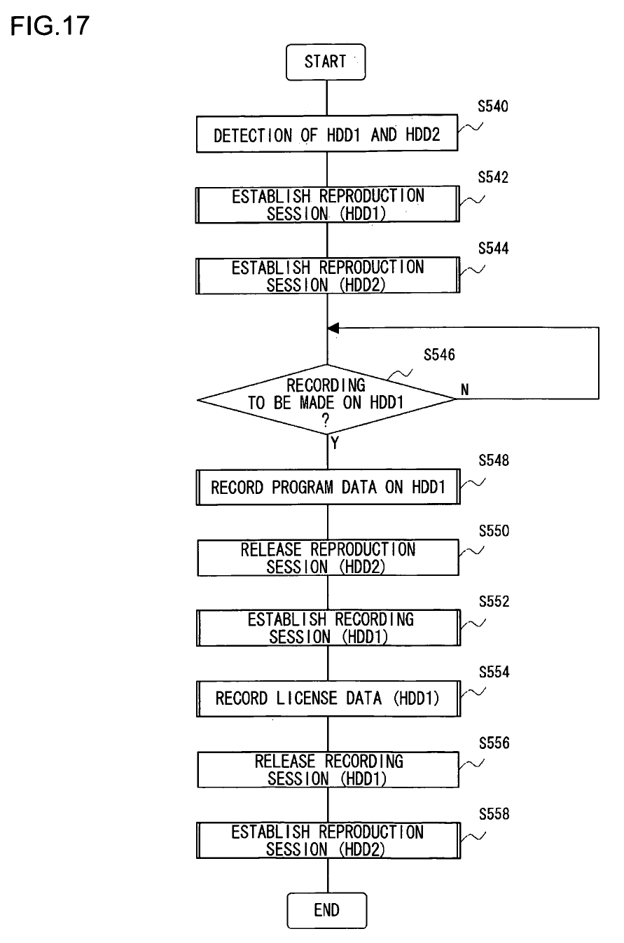

FIG. 17 shows the procedure for recording the program data on one of the removable HDD units 300 in the state which allows the recording/reproduction device 10 to use the two removable HDD units 300. As described above, in a case wherein the two removable HDD units 300 can be used (S540), the recording/reproduction device 10 establishes the reproduction sessions for each of the removable HDD units 300 (S542 and S544), whereby each of the two removable HDD units 300 enters the standby state for reproduction. In this stage, upon giving instructions to one of the removable HDD units 300 for recording the program data (in a case of “Yes” in S546), the processing from S100 up to S110 shown in FIG. 11 is executed, whereby the program data is recorded on the removable HDD unit 300 (S548). Prior to recording of the license data for the program on the removable HDD unit 300, the session management unit 103 temporarily releases the reproduction session for one of the removable HDD units 300 (S550), establishes the recording session for the removable HDD unit 300 on which the license data is to be recorded (S552), and executes the processing in S114 shown in FIG. 8, whereby the license data is recorded on the removable HDD unit 300 (S554). Upon completion of recording of the license data, the session management unit 103 releases the recording session (S556), and establishes the reproduction session for the removable HDD unit 300 for which the reproduction session has been released in the previous stage (S558), whereby both the removable HDD units 300 enter the standby state for reproduction.

### Third Embodiment

Description will be made in the present embodiment regarding an arrangement which allows the user to connect the two removable HDD units 300 to the recording/reproduction device 10, and performs processing with three secure sessions in parallel. The recording/reproduction device 10 according to the present embodiment has the same configuration as with the recording/reproduction device 10 according to the second embodiment shown in FIG. 13.

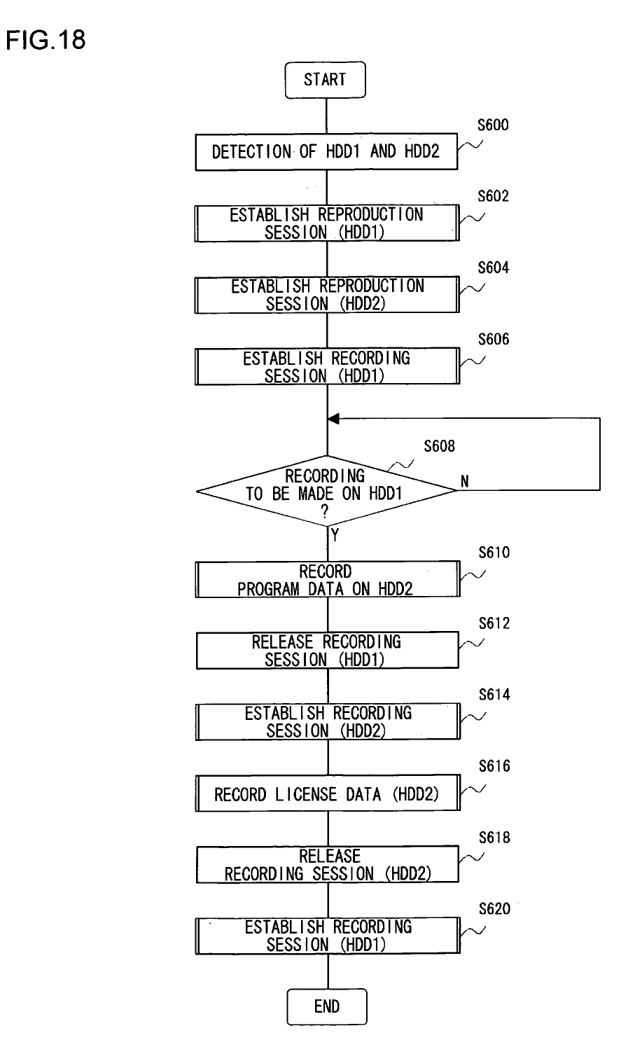

FIG. 18 shows an example of transition between the sessions regarding the recording/reproduction device 10 according to the present embodiment. Upon detection of the two removable HDD units 300a and 300b (S600), the session management unit 103 establishes the reproduction sessions for both the removable HDD units 300a and 300b (S602 and S604). At the same time, the session management unit 103 establishes the recording session for the removable HDD unit 300a which is one of these two removable HDD units (S606). At this time, the removable HDD unit 300a, which is one of the removable HDD units, enters the standby state for both recording and reproduction. On the other hand, the removable HDD unit 300b, which is the other removable HDD unit, enters the standby state for reproduction alone. Note that the session management unit 103 may determine which removable HDD unit 300 the recording session is assigned to, based upon predetermined conditions. For example, the session management unit 103 may determine which removable HDD unit 300 the recording session is assigned to with high priority, by referring to the storage capacity, the remaining available storage, and the history of recording/reproduction, of each removable HDD unit 300. Furthermore, the session management unit 103 may assign the recording session to the removable HDD unit 300 which has greater remaining available storage, with high priority. Furthermore, the session management unit 103 may assign the recording session to the removable HDD unit 300 on which the program data has been recorded, with high frequency, as a result of referring to the recording history.

Now, in a case of giving instructions to the removable HDD unit 300b for which the recording session has not been established, for recording of the program data (in a case of “Yes” in S608), there is the need to release one of the established sessions for establishing the necessary recording session. While the session management unit 103 may release any of these sessions, the reproduction sessions are preferably maintained with high priority. With the present embodiment, following recording of the program data on the removable HDD unit 300b (S610), the session management unit 103 releases the recording session for the removable HDD unit 300a (S612), and establishes the recording session for the removable HDD unit 300b instead of the recording session for the removable HDD unit 300a thus released (S614). This allows the recording/reproduction device 10 to record the license data on the removable HDD unit 300b while maintaining the reproduction sessions for each of the removable HDD units 300a and 300b, thereby reducing the delay at the time of reproduction. Upon completion of recording of the license data on the removable HDD unit 300b (S616), the session management unit 103 releases the recording session for the removable HDD unit 300b (S618), and establishes the recording session for the removable HDD unit 300a, i.e., the previous state (S620). While description has been made regarding an arrangement wherein, following completion of recording, the session state is returned to the previous state, an arrangement may be made wherein, following completion of recording, the session state is not returned to the previous state, but is kept in this state.

### Fourth Embodiment

Description will be made in the present embodiment regarding the recording/reproduction device 10 which allows the user to connect a predetermined number of removable HDD units 300 thereto, and can perform processing with a predetermined number of secure sessions in parallel. With the present embodiment, in a case wherein the number of the removable HDD units 300 which can be used is smaller than the number of the sessions which can be used, the session management unit 103 provides the reproduction sessions for all of the removable HDD units 300, and assigns the remaining secure sessions as the recording sessions. Upon the recording/reproduction device 10 making a recording request to the removable HDD unit 300 for which the recording session has not been established, the session management unit 103 handles such a situation by releasing one of the recording sessions and establishing the necessary recording session instead of the recording session thus released in an appropriate manner following the procedure shown in FIG. 18. In a case of detection of the new removable HDD unit 300 which can be used, the session management unit 103 releases one of the recording sessions, and establishes the reproduction session for the new removable HDD unit 300 which can be used. In the event that one of the removable HDD units 300 has enters the state wherein the removable HDD unit 300 cannot be used, the session management unit 103 releases the reproduction session established for the removable HDD unit 300, and establishes the recording session for one of the removable HDD units 300 for which the recording sessions have not been established.

On the other hand, in a case wherein the number of the removable HDD units 300 which can be used is the same as the number of the sessions which can be used, the session management unit 103 establishes the reproduction sessions for all of the removable HDD units 300. Upon the recording/reproduction device 10 making a recording request to one of the removable HDD units 300, the session management unit 103 releases the reproduction session established for one of the removable HDD units 300, and establishes the recording session for the removable HDD unit 300 on which the program data is to be recorded. The session management unit 103 may release the reproduction session for the removable HDD unit 300 on which the program data is to be recorded. Furthermore, the session management unit 103 may release the reproduction session for the removable HDD unit 300 other than the removable HDD unit 300 on which the program data is to be recorded. The session management unit 103 may determine the removable HDD unit 300 corresponding to the reproduction session which is to be released, based upon the storage capacity, the remaining available storage, the number of the recorded programs, the frequency of reproduction, and so forth, regarding each removable HDD unit 300. Upon completion of recording of the program, the session management unit 103 releases the recording session, and establishes the reproduction session as in the previous state. In a case of detection of a new removable HDD unit 300 which can be used, the session management unit 103 establishes the reproduction session instead of one of the other removable HDD units 300, as necessary. On the other hand, in the event that one of the removable HDD units 300 enters the state wherein the removable HDD unit 300 cannot be used, the session management unit 103 releases the reproduction session established for the removable HDD unit 300 which cannot be used, and establishes the recording session for one of the remaining removable HDD units 300.

On the other hand, in a case wherein the number of the removable HDD units 300 which can be used is greater than the number of the sessions which can be used, the session management unit 103 selects the removable HDD units 300 for which the reproduction session are established, and establishes the reproduction sessions for these removable HDD units 300 thus selected. Upon the recording/reproduction device 10 making a recording request to one of the removable HDD units 300, the session management unit 103 releases the reproduction session established for one of the removable HDD units 300, and establishes the recording session for the removable HDD unit 300 on which the program data is to be recorded. Upon completion of recording of the program, the session management unit 103 releases the recording session, and establishes the reproduction session again as in the previous state. In a case of detection of the new removable HDD unit 300 which can be used, the session management unit 103 establishes the reproduction session instead of one of the other removable HDD units 300, as necessary. On the other hand, in the event that one of the removable HDD units 300 enters the state wherein the removable HDD unit 300 cannot be used, the session management unit 103 releases the reproduction session established for the removable HDD unit 300 which cannot be used, and establishes the reproduction session for one of the remaining removable HDD units 300.

### Fifth Embodiment

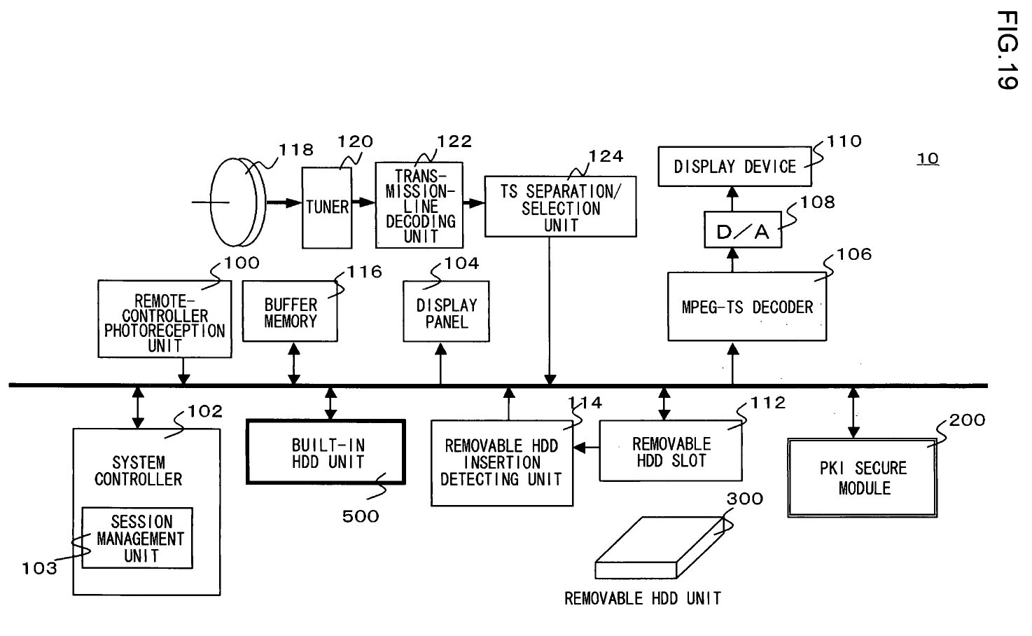

FIG. 19 shows a configuration of the recording/reproduction device 10 according to a fifth embodiment. The recording/reproduction device 10 according to the present embodiment includes a single built-in HDD unit 500 and the single removable HDD slot 112 which allows the user to connect the single removable HDD unit 300. The other components are the same as with the recording/reproduction device 10 according to the first embodiment shown in FIG. 1. The PKI secure module 200 and the PKI secure module 330 according to the present invention have a function for parallel processing with two secure sessions, as well. Note that the session management unit 103 manages the two secure sessions.

The built-in HDD unit 500 is handled in the same way as in a case wherein a removable HDD unit has been inserted at the time of turning on the power supply. In this case, the built-in HDD unit 500 can be considered to be available at all times after turning on the power supply. Furthermore, an arrangement may be made wherein the recording/reproduction device 10 checks whether or not the built-in HDD unit 500 is available by electric access. For example, an arrangement may be made wherein the system controller 102 issues an “Identify Device” command, stipulated by the ATA, to the built-in HDD unit 500, and upon reception of the response, the recording/reproduction device 10 determines that the built-in HDD unit 500 is available. The built-in HDD unit 500, which has become available, performs the same operation as with the removable HDD unit 300 which has become available.

Let us consider an application of the state-transition diagram shown in FIG. 14 to the operation of the recording/reproduction device 10 shown in FIG. 19. With such a configuration, the built-in HDD unit 500 is always detected at the time of turning on the power supply, and accordingly, the recording/reproduction device 10 does not enter “the state wherein insertion of no removable HDD is detected” shown in FIG. 14. Furthermore, “the state wherein insertion of the single removable HDD unit is detected” and “the state wherein insertion of the two removable HDD units is detected” shown in FIG. 14 are replaced with “the state wherein the single HDD is available” and “the state wherein the two HDDs are available” in this application. Furthermore, “the state wherein the single removable HDD unit 300 is detected at the time of turning on the power supply” in a case of the state transition (2) shown in FIG. 14 is replaced with “the state wherein the built-in HDD unit 500 is detected at the time of turning on the power supply” in this application. Furthermore, “the state wherein the two removable HDD units 300 are detected at the time of turning on the power supply” in a case of the state transition (3) in FIG. 14 is replaced with “the state wherein the built-in HDD unit 500 and the single removable HDD unit 300 are detected at the time of turning on the power supply” in this application. Furthermore, “the state wherein the connection remains between the recording/reproduction device 10 and the single removable HDD unit 300 as a result of disconnection of the other removable HDD unit 300” in a case of the state transition (6) shown in FIG. 14 is replaced with “the state wherein the connection remains between the recording/reproduction device 10 and the built-in HDD unit 500 alone as a result of disconnection of the removable HDD unit 300” in this application. The recording/reproduction device 10 according to the present embodiment does not perform operation of the state transition (1), (4), and (7). Note that the recording/reproduction device 10 according to the present embodiment performs the same operations as those shown in FIGS. 16, 17, and 18, except that one of the two removable HDD units 300 is replaced with the built-in HDD unit 500, and accordingly, description thereof will be omitted.

As described above, with the present embodiment, the session management unit 103 assigns the secure sessions, which allow parallel processing, for reproduction with high priority. This allows as large a number of the removable HDD units 300 as possible to enter the standby state for reproduction, thereby reducing delay at the time of reproduction. Furthermore, following the session management unit 103 assigning the secure sessions for reproduction, in the event that there are any remaining secure sessions which allow parallel processing, the session management unit 103 assigns the remaining secure sessions for recording, thereby enabling smooth processing for recording.

As described above, description has been made regarding the present invention with reference to the aforementioned embodiments. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

While description has been made in the aforementioned embodiments regarding an arrangement wherein the session management unit 103 establishes the single recording session and the single reproduction session for each removable HDD unit 300, an arrangement may be made wherein the session management unit 103 assigns the multiple recording sessions and reproduction sessions for each removable HDD unit 300 in a case wherein the recording/reproduction device 10 has a function for reproducing two or more contents on the display screen divided into multiple regions, at the same time, for example. In this case, such a arrangement wherein the session management unit 103 assigns the secure sessions for reproduction with high priority reduces delay at the time of reproduction in the same way. Furthermore, while description has been made in the aforementioned embodiments regarding an arrangement wherein the removable HDD unit 300 is employed as a storage medium, an arrangement may be made wherein the storage medium is built into the recording/reproduction device 10. Note that the removable HDD unit 300 according to the aforementioned embodiments may be packaged with the recording/reproduction device 10 at the time of shipping. Also, the user may purchase the removable HDD unit 300 from a vendor or the like, separately from the recording/reproduction device 10.

1. A recording/reproduction device comprising:
a cryptography processing unit having a configuration which allows execution of a series of cryptography input/output processing actions in parallel, for encrypting the data which is to be kept secret, so as to be input/output to/from a storage medium for storing the data; and
a management unit for managing said plurality of cryptography input/output processing actions,
wherein, in the event that said storage medium enters the state wherein said storage medium can be used, said management unit instructs said cryptography processing unit to execute session establishment processing including at least part of said series of cryptography input/output processing actions,
and wherein reproduction session establishment processing for reading out said data, which is to be kept secret, from said storage medium is executed with higher priority than with recording session establishment processing for writing said data, which is to be kept secret, to said storage medium.

2. A recording/reproduction device according to claim 1, wherein said storage medium is provided for a storage device removably mounted on said recording/reproduction device,
and wherein said recording/reproduction device has a configuration which allows the user to connect said plurality of storage devices thereto, and further includes a detecting unit for detecting whether or not each of said plurality of storage devices is connected to said recording/reproduction device.

3. A recording/reproduction device according to claim 2, wherein said session establishment processing includes processing wherein a device serving as a source of said data which is to be kept secret authenticates a device serving as a destination for said data which is to be kept secret.

4. A recording/reproduction device according to claim 1, wherein, in the event that the number of said storage media, which are connected to said recording/reproduction device and can be used, is smaller than the number of said cryptography input/output processing actions which said cryptography processing unit can execute in parallel, said management unit instructs said cryptography processing unit to execute said reproduction session establishment processing for allowing exchange of information between said recording/reproduction device and each storage medium which can be used, thereby enabling said cryptography processing unit to perform subsequent readout of said data, which is to be kept secret, from each storage medium without said reproduction session establishment processing until said storage medium enters the state wherein said storage medium cannot be used.

5. A recording/reproduction device according to claim 2, wherein, in the event that the number of said storage media, which are connected to said recording/reproduction device and can be used, is smaller than the number of said cryptography input/output processing actions which said cryptography processing unit can execute in parallel, said management unit instructs said cryptography processing unit to execute said reproduction session establishment processing for allowing exchange of information between said recording/reproduction device and each storage medium which can be used, thereby enabling said cryptography processing unit to perform subsequent readout of said data, which is to be kept secret, from each storage medium without said reproduction session establishment processing until said storage medium enters the state wherein said storage medium cannot be used.

6. A recording/reproduction device according to claim 3, wherein, in the event that the number of said storage media, which are connected to said recording/reproduction device and can be used, is smaller than the number of said cryptography input/output processing actions which said cryptography processing unit can execute in parallel, said management unit instructs said cryptography processing unit to execute said reproduction session establishment processing for allowing exchange of information between said recording/reproduction device and each storage medium which can be used, thereby enabling said cryptography processing unit to perform subsequent readout of said data, which is to be kept secret, from each storage medium without said reproduction session establishment processing until said storage medium enters the state wherein said storage medium cannot be used.

7. A recording/reproduction device according to claim 1, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

8. A recording/reproduction device according to claim 2, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

9. A recording/reproduction device according to claim 3, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

10. A recording/reproduction device according to claim 4, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

11. A recording/reproduction device according to claim 5, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

12. A recording/reproduction device according to claim 6, wherein, in the event that the number of said storage media, which are connected to said recording/reproduction device and can be used, is equal to or greater than the number of said cryptography input/output processing actions which said cryptography processing unit can execute in parallel, at the time of writing said data which is to be kept secret, to said storage medium, said management unit instructs said cryptography processing unit to release one of said reproduction sessions thus established for said storage media, and to execute said cryptography input/output processing for writing said data which is to be kept secret, to said storage medium, following which said management unit instructs said cryptography processing unit to execute said reproduction session establishment processing again.

13. A recording/reproduction method wherein a series of cryptography input/output processing actions is executed in parallel for encrypting the data which is to be kept secret for input/output of said encrypted data to/from a storage medium for storing data comprising:
a step wherein, in the event that said storage medium enters the state wherein said storage medium can be used, reproduction session establishment processing is executed, which includes at least part of said series of cryptography input/output processing actions for reading out said data which is to be kept secret, from said storage medium;
a step wherein, in the event that there are any sessions which can be established in parallel for executing said series of cryptography input/output processing actions after execution of said reproduction session establishment processing for said storage medium which can be used, recording session establishment processing is executed, which includes at least part of said series of cryptography input/output processing actions for writing said data which is to be kept secret, to said storage medium;
awaiting instructions for readout of said data which is to be kept secret, after execution of said reproduction session establishment processing; and
a step wherein, in a case of reception of said instructions of readout of said data, said reproduction session establishment processing of said series of cryptography input/output processing is skipped, and the subsequent processing thereof is executed.
